(19) United States
(12) Patent Application Publication
(10) Pub. No.: US 2026/0230855 A1
(43) Pub. Date: Aug. 6, 2026

(54) APPARATUS AND METHOD FOR ACQUIRING INFORMATION FOR QOS ANALYTICS IN WIRELESS COMMUNICATION SYSTEM

(71) Applicant: ELECTRONICS AND TELECOMMUNICATIONS RESEARCH INSTITUTE, Daejeon (KR)

(72) Inventors: Jeoung Lak HA, Daejeon (KR); Changki KIM, Daejeon (KR); Tae Yeon KIM, Daejeon (KR); Chang Sik LEE, Daejeon (KR)

(73) Assignee: ELECTRONICS AND TELECOMMUNICATIONS RESEARCH INSTITUTE, Daejeon (KR)

(21) Appl. No.: 19/366,122

(22) Filed: Oct. 22, 2025

(30) Foreign Application Priority Data
Feb. 6, 2025 (KR) 10-2025-0015261
Sep. 8, 2025 (KR) 10-2025-0127623

(51) Int. Cl. H04W 24/02; G06N 5/04; H04W 24/08

(52) U.S. Cl. CPC H04W 24/02; G06N 5/04; H04W 24/08

(57) ABSTRACT

The present disclosure generally relates to wireless communication systems, and more specifically, to an apparatus and method for a Network Data Analytics Function to acquire frequency information and Radio Access Technology type information for Quality of Service analysis in a wireless communication system. A method of operation of NWDAF comprises receiving, from a Consumer NF, an analytics request for ‘QoS and Policy Assistance’ including analytics filter information that includes at least one of RAT type or frequency; collecting, based on the analytics request, at least one of RAT type information or frequency information associated with UE or PDU Session or QoS Flow; inferring ‘QoS and Policy Assistance’ analytics based on the collected information; and providing the inferred analytics to Consumer NF.

### CROSS REFERENCE TO RELATED APPLICATION

This application claims priority to Korean Patent Application No. 10-2025-0015261, filed on Feb. 6, 2025, and Korean Patent Application No. 10-2025-0127623, filed on Sep. 8, 2025, the entire contents of which are hereby incorporated by reference.

### BACKGROUND OF THE INVENTION

### Field of the Invention

The present disclosure generally relates to wireless communication systems, and more specifically, to an apparatus and method for a Network Data Analytics Function (NWDAF) to acquire frequency information and Radio Access Technology (RAT) type information for Quality of Service (QoS) analysis in a wireless communication system.

### Description of the Related Art

In 5G networks, various technologies such as network slicing, QoS management, and artificial intelligence-based network optimization are being introduced to satisfy diverse service requirements. Particularly, the Network Data Analytics Function (NWDAF) serves as a core component of the 5G core network, responsible for collecting and analyzing network data to provide network performance prediction and optimization information.

Conventional NWDAF collects Qos-related information from 5G core network function elements such as AMF (Access and Mobility Management SMF Function), (Session Management Function), UPF (User Plane Function), and OAM (Operations, Administration, and Maintenance) to perform analysis. These analysis results are provided to Consumer NFs such as PCF (Policy Control Function) and utilized for QoS policy establishment.

However, conventional NWDAF technology has not systematically presented methods for collecting and utilizing frequency information and RAT (Radio Access Technology) type information necessary to improve the accuracy of QoS analysis. Particularly, there is a lack of QoS analysis technology that considers different performance characteristics for each frequency band and RAT type in wireless environments.

Due to these limitations, conventional technology has been constrained in providing accurate Qos prediction and policy establishment that sufficiently reflects location-specific, frequency-specific, and RAT type-specific network performance characteristics.

### SUMMARY OF THE INVENTION

Based on the above discussion, the present disclosure provides an apparatus and method for NWDAF to efficiently acquire frequency information necessary for QoS and Policy Assistance Analytics in a wireless communication system.

Additionally, the present disclosure provides an apparatus and method for NWDAF to efficiently acquire RAT type information necessary for QoS and Policy Assistance Analytics in a wireless communication system.

Furthermore, the present disclosure provides an apparatus and method for performing enhanced QoS analysis and prediction based on acquired frequency information and RAT type information in a wireless communication system.

According to various embodiments of the present disclosure, a method of operation of NWDAF for acquiring information for QoS analysis in a wireless communication system comprises: receiving, from a Consumer NF, an analytics request for ‘QoS and Policy Assistance’ including analytics filter information that includes at least one of RAT type or frequency; collecting, based on the analytics request, at least one of RAT type information or frequency information associated with a UE or PDU Session or QoS Flow; inferring ‘QoS and Policy Assistance’ analytics based on the collected information; and providing the inferred analytics to the Consumer NF.

According to various embodiments of the present disclosure, an NWDAF apparatus for acquiring information for Qos analysis in a wireless communication system comprises a transceiver and a controller operatively connected to the transceiver, wherein the controller is configured to: receive, from a Consumer NF, an analytics request for ‘QoS and Policy Assistance’ including analytics filter information that includes at least one of RAT type or frequency; collect, based on the analytics request, at least one of RAT type information or frequency information associated with a UE or PDU Session or QoS Flow; infer ‘QoS and Policy Assistance’ analytics based on the collected information; and provide the inferred analytics to the Consumer NF.

The apparatus and method according to various embodiments of the present disclosure enable NWDAF to perform more accurate and detailed QoS analysis and prediction by acquiring frequency information and RAT type information from Radio Access Network (RAN), Core Network Function (NF), or OAM.

Additionally, the apparatus and method according to various embodiments of the present disclosure enable Policy Control Function (PCF) to establish more efficient QoS policies by providing analysis results that consider location-specific, frequency-specific, and RAT type-specific performance characteristics.

Effects obtainable from the present disclosure are not limited to the effects mentioned above, and other effects not mentioned will be clearly understood by those having ordinary skill in the technical field to which the present disclosure belongs from the description below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating a network structure of a 5G wireless communication to various system according embodiments of the present disclosure.

FIG. 2 is a diagram illustrating a process of information collection and analysis information provision by NWDAF according to an embodiment of the present disclosure.

FIG. 3 is a diagram illustrating an overall flow of an information acquisition method for QoS analysis by NWDAF according to an embodiment of the present disclosure.

FIG. 4 is a diagram showing a configuration of a network function apparatus in a wireless communication system according to an embodiment of the present disclosure.

### DETAILED DESCRIPTION OF THE INVENTION

Terms used in the present disclosure are used only to describe specific embodiments and may not be intended to limit the scope of other embodiments. Singular expressions may include plural expressions unless the context clearly indicates otherwise. Terms used herein, including technical or scientific terms, may have the same meaning as commonly understood by those of ordinary skill in the technical field described in the present disclosure. Among terms used in the present disclosure, terms defined in general dictionaries may be interpreted with meanings identical or similar to meanings in the context of related technology, and unless clearly defined in the present disclosure, they are not interpreted with ideal or excessively formal meanings. In some cases, even terms defined in the present disclosure cannot be interpreted to exclude embodiments of the present disclosure.

Various embodiments of the present disclosure described below illustrate hardware-based approaches as examples. However, since various embodiments of the present disclosure include technologies using both hardware and software, various embodiments of the present disclosure do not exclude software-based approaches.

Additionally, in the detailed description and claims of the present disclosure, “at least one of A, B, and C” may mean “only A,” “only B,” “only C,” or “any combination of A, B, and C.” Also, “at least one of A, B, or C” or “at least one of A, B, and/or C” may mean “at least one of A, B, and C.”

The present disclosure relates to an apparatus and method for acquiring information for QoS analysis in a wireless communication system. Specifically, the present disclosure describes technology for NWDAF to efficiently acquire frequency information and RAT type information for QoS and policy assistance analytics and provide enhanced analysis results in a wireless communication system.

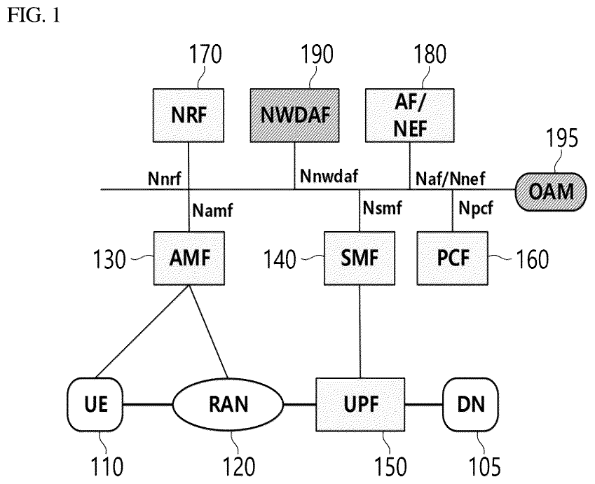

FIG. 1 illustrates a network structure of a 5G wireless communication system according to various embodiments of the present disclosure.

Referring to FIG. 1, UE 110 is a user device connected to the network, including smartphones, tablets, IoT devices, and the like. RAN 120 manages wireless connections with UE 110 and connects to the core network.

User equipment UE 110 accesses the core network through access network RAN 120. The functional elements of the core network are as follows. AMF 130 handles mobility management and connection establishment in the core network. SMF 140 manages PDU Sessions and resource allocation for user data sessions. UPF 150 routes and forwards user data packets between RAN 120 and external data network DN 105. PCF 160 provides policy information to AMF 130 or SMF 140, and service quality is determined according to the policy information. NRF 170 maintains a repository of network functions and services to support discovery and communication of network functional elements. AF (Application Function) provides application services and provides information necessary for policy establishment that enables smooth application usage to the core network. AF communicates directly with the core network or through NEF. NEF (Network Exposure Function) exposes core network functions to external applications and services. AF/NEF 180 includes these functions.

NWDAF 190 is a core component of the present disclosure, which receives QoS and policy assistance analytics requests from Consumer NFs, collects various network data including frequency information and RAT type information, analyzes them, and provides analysis results to Consumer NFs.

Each network function of the access network and core network is connected to OAM 195. OAM 195 monitors performance and manages resources through operation, administration, and maintenance of the network.

FIG. 1 shows that each element of the core network is connected via a Service-Based Interface (SBI). For convenience, the OAM (195) connections to each network function in both the access network and the core network are represented as connections to the core network and are shown within the SBI connection network

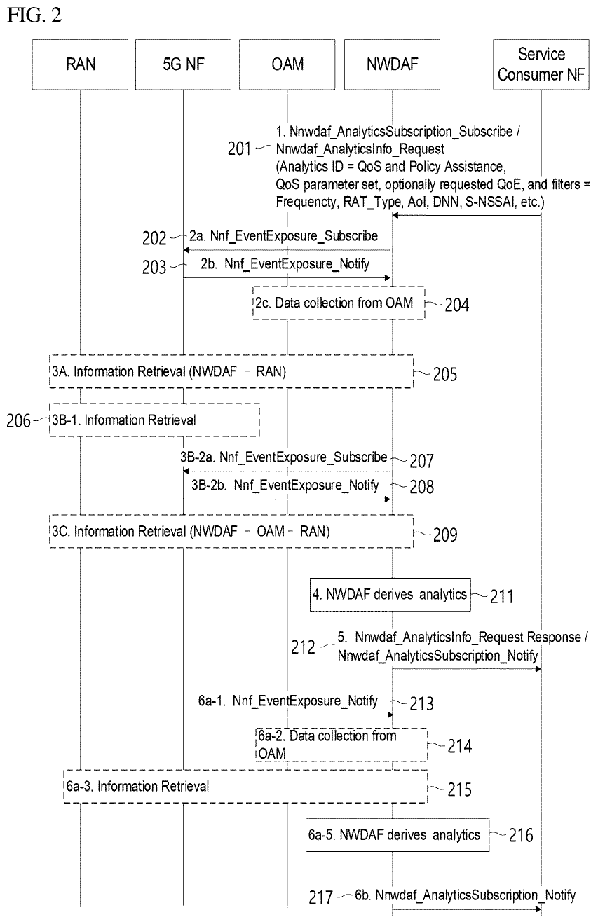

FIG. 2 illustrates information collection and analysis information provision by NWDAF according to an embodiment of the present disclosure.

Referring to FIG. 2, NWDAF collects information for corresponding analysis from RAN or 5G NF according to analytics requests from Consumer NF, analyzes the collected information, and provides performance prediction information.

In step 201, a QoS and Policy Assistance Analytics request is received from Consumer NE through either Nnwdaf_AnalyticsSubscription Subscribe or Nnwdaf_AnalyticsInfo Request. The corresponding analytics request information includes QoS parameters and may further include required QoE or filters.

In steps 202, 203, and 204, information necessary for corresponding analysis is collected through 5G NF and OAM. The EventExposure services in steps 202 and 203 are examples, and services other than EventExposure services defined for each NF may be used. Any one or more of steps 202, 203, and 204 may be used.

In step 202, information necessary for analysis is requested for subscription to each NE through

EventExposure Subscribe service.

In step 203, information necessary for analysis is received from each NF through EventExposure Notify service.

In step 204, information necessary for analysis is received from OAM.

In steps 205, 206, 207, 208, and 209, RAT type information or frequency information is collected through RAN.

Any one or more of RAT type or frequency used by the corresponding UE, RAT type or frequency used by the corresponding PDU Session, RAT type or frequency used by the corresponding QoS Flow, or RAT type or frequency used by traffic of the corresponding application may be collected.

Here, frequency may be any one or more of a number representing individual frequency or a value representing frequency band. Any one or more of steps 205, 206, 207, 208, and 209 may be used.

In step 205, NWDAF directly collects frequency information from RAN.

In steps 206, 207, and 208, 5G NF collects frequency information from RAN, and NWDAF re-collects the corresponding frequency information from 5G NF. In step 206, 5G NF collects information from RAN, step 207 performs NE

EventExposure Subscribe, and step 208 performs NF

### EventExposure Notify.

In step 209, OAM collects frequency information from RAN, and NWDAF re-collects the corresponding frequency information from OAM. This may include the process of step 204.

In step 211, NWDAF infers analysis based on information collected through the process of steps 202 to 204 or steps 205 to 209.

In step 212, the analysis generated in the process of step 211 is provided to Consumer NF. A corresponding message is used according to the request of

Nnwdaf_AnalyticsSubscription Subscribe or Nnwdaf_AnalyticsInfo Request received in the process of step 201.

In steps 213, 214, 215, 216, and 217, when a request is received through Nnwdaf_AnalyticsSubscription Subscribe in the process of step 201, analysis is inferred from information received from 5G NF, OAM, and RAN, and the inferred result is provided to Consumer NF.

Step 213 corresponds to step 203 or step 208, step 214 corresponds to step 204, and step 215 may correspond to step 205 or step 209. Step 216 corresponds to the process of step 211, and step 217 corresponds to the process of step 212. Any one of steps 202 to 204, steps 205 to 209, and step 211 above may be performed before step 201. According to one embodiment, Consumer NF may be PCF.

In 5G networks, to manage and optimize QoS, NWDAF monitors and analyzes network performance to support PCF in effective applying and adjusting QoS policies.

NWDAF can provide expected QoS using QoS and Policy Assistance Analytics as Request-Response services or Subscribe-Notify services.

NWDAF can provide expected QoS when using specific QoS parameters for specific UEs or groups of UEs.

Terms referring to signals, terms referring to channels, terms referring to control information, terms referring to network entities, and terms referring to components of devices used in the following description are exemplified for convenience of description. Therefore, the present disclosure is not limited to the terms described below, and other terms having equivalent technical meanings may be used.

Also, the present disclosure describes various embodiments using terms used in some communication standards (e.g., 3GPP (3rd Generation Partnership Project)), but this is merely an example for description. Various embodiments of the present disclosure can be easily modified and applied to other communication systems.

### [Analytics Service Request]

The analytics request in step 201 of FIG. 2 is a request to obtain expected QoS that can be obtained when applying QoS parameters used by specific UEs or groups of UEs and values for corresponding parameters. The corresponding Request or Subscribe may include the following as shown in Table 1.

Table 1 shows information provided when requesting QoS and Policy Assistance Analytics according to one embodiment.

TABLE 1

Analytics ID = ″QoS and Policy Assistance″ --
Identifier of required analysis
Target of Analytics Reporting -- Identifier or
information about UE or groups of UEs to be analyzed
A list of one or more QoS parameter set(s) and
optionally associated QoS parameter set ID(s). Based on
the consumer decision (i.e., PCF), each QoS parameter
set(s) may include the following individual parameters and
non-empty value list(s) for each individual parameter(s):
One or more QoS parameter sets and candidate value
lists to analyze for each parameter
5QI (standardized or pre-configured), or
And optionally for GBR 5QI(s): GBR and MBR.
QoS characteristics attributes (as defined in clause
5.7.3 of TS 23.501 [2]): Resource Type, Priority
Level, PDB, PER, Averaging Window, Maximum Data
Burst Volume.
NOTE 1: In the case of standardized and pre-
configured 5QI(s), the specified/configured QoS
parameters and QoS characteristics may be pre-
configured into NWDAF by operators, subject to
operator policy.
NOTE 2: QoS characteristics may be included in
the QoS parameter set(s) only in the case of
dynamically assigned non-standardized 5QI(s).
Application ID or SDF template(s) -- Specification for
applications or traffic to be analyzed
Optionally, a requested QoE that indicates the NWDAF to
only provide the QoS parameter set(s) and their
corresponding value(s) for which the predicted QoE is
equal to or higher than the requested QoE.
Analytics Filter Information optionally includes:
DNN -- DNN to be used for the corresponding
application
Area of Interest (AOI(s)) -- Physical area to be
used by the corresponding application
NOTE 3: A service consumer can use the AOI(s)
in order to reduce the amount of signaling that
the analytics subscription or request
generates.
S-NSSAI and NSI ID -- Identifier of network slice to
used by the corresponding application
List of analytics subsets that are requested, e.g.,
parameter(s) in QoS parameter set(s).
RAT Type -- Radio Access Technology Type to be used
by the corresponding application
Frequency -- Frequency or Frequency Band information
to be used by the corresponding application
An Analytics target period indicates the time period
over which the analytics are requested.
In a subscription, the Notification Correlation Id and
the Notification Target Address are included.
Optionally, preferred order of results for the list of
candidate QoS parameter sets and the predicted QoE
associated to each candidate QoS parameter sets:
ordering criterion: ″QoE″ or ″usage duration″ or
″number of usages″ of a QoS flow,
order: ascending or descending.
Optionally, reporting Thresholds, which apply only for
subscriptions and indicate conditions on the levels to be
reached for the reporting of respective analytics subsets.
Optionally, maximum number of objects and maximum
number of SUPIs.
Optionally, referred granularity of location
information: TA level, cell level or ″longitude and
latitude level″.

### [Data Collection]

To perform requested analysis, NWDAF must collect related data, and related data may be one or more of the following as shown in Tables 2 and 3.

Table 2 shows performance measurements collected from network function elements for QoS and Policy Assistance Analytics and information related to the performance measurements according to one embodiment.

TABLE 2

| Information | Source | Description |
|---|---|---|
| QFI allocation or QFI | SMF | SMF provides such event when specific QoS parameters are applied or |
| deallocation events (1 ... max) | | released from certain QoS flow(s). |
| > Used QoS parameter set(s) | SMF | The QoS parameter set(s) that have been already applied by SMF. |
| | | As detailed in clause 6.23.1, the QoS parameter set includes 5QI or QoS |
| | | characteristics attributes and optionally GFBR and MFBR for GBR flows . |
| > Used QoS profile | SMF | The QoS profile associated to the used QoS parameter set(s). |
| > Traffic descriptor | SMF | One of Application Identifier, IP Packet Filter Set or Ethernet Packet Filter |
| | | Set |
| > S-NSSAI | SMF | Slice used to transport the QoS flow(s). |
| > DNN | SMF | DNN associated with the QoS flow(s). |
| > DNAI | SMF | Identifies the access to the DN that the PDU Session is connected to. |
| UE identifier | SMF, AMF | The identifier of UE, e.g. SUPI, UE IP address, etc. |
| UE Location | AMF | The UE location information, e.g. cell ID or TAI. |
| Frequency | RAN, | Frequency or frequency band information used by UE or PDU Session |
| | AMF | |
| RAT Type | SMF, AMF | RAT Type information used by UE or PDU Session |
| Time stamp | SMF, AMF | The time stamp associated to the collected data. |
| N6 Delay (NOTE 1) | UPF | The observed N6 delay between the UPF and measurement endpoint in |
| | | the DN, as defined in clause 5.8.2.23 of TS 23.501 [2]. |
| Packet Loss Rate (NOTE 2) | UPF | The Packet Loss Rate for uplink and/or downlink. |

NOTE 1:
Whether and how N6 delay (independent of QoS profile) is considered to derive the analytics in comparison to delay between UE and UPF (dependent on the QoS profile) is left to implementation based on the operator's policy.
NOTE 2:
The Packet Loss Rate is applicable to the TCP traffic for which the UPF is able to provide the information.

Table 3 shows performance measurements collected from OAM for Qos and Policy Assistance Analytics and information related to the performance measurements according to one embodiment.

TABLE 3

| Information | Source | Description |
|---|---|---|
| UL/DL GTP | OAM | Average UL/DL packet delay measurement on N3 between |
| packet delay | | NG-RAN and PSA UPF, as defined in clause 5.4.7 of |
| | | TS 28.552 [8]. |
| Delay in RAN | OAM | Average Uplink and Downlink packet transmission delay over |
| | | the air interface, as defined in clause 5.1.1.1 of TS 28.552 [8]. |
| RAT Type | OAM | RAT Type information used by UE or PDU Session (The |
| | | corresponding RAN may apply the same RAT type to all |
| | | UEs or PDU Sessions. ) |
| Frequency | OAM | Frequency or frequency band |
| | | information used by UE or PDU |
| | | Session (The corresponding RAN may |
| | | apply the same Frequency band to |
| | | all UEs or PDU Sessions. ) |

### [Frequency]

NWDAF can analyze performance by frequency or frequency band used. For this purpose, NWDAF collects information on frequency or frequency band used by UE or PDU Session or QoS Flow from RAN, and can use this in combination with performance measurements and information related to performance measurements collected from AMF, SMF, UPF, or OAM as shown in Table 2 or Table 3 for analysis. By combining performance measurements and information related to performance measurements of specific UE or specific PDU Session or QoS Flow or application collected from SMF or UPF with frequency information used by the corresponding UE, performance when using specific frequency at specific location can be inferred and predicted. In addition, performance can be inferred and predicted by further considering one or more of the parameters described above such as QFI, QoS parameters, QoS profile, Traffic Descriptor of application, S-NSSAI, DNN, DNAI, and location.

NWDAF can request and receive frequency or frequency band information used by specific UE or specific PDU Session or QoS Flow from RAN or 5G NF. Here, RAN includes entities that allocate radio resources for specific UE or specific PDU Session or QoS Flow, such as gNB, AN (Access Network), or RAN-Central Unit.

NWDAF can also request and receive frequency or frequency band information used by specific UE or specific PDU Session or QoS Flow from a 5G NF(s). Said 5G NF only needs to be a functional element that can know radio resource information for specific UE or specific PDU Session or QoS Flow, and the corresponding 5G NF can receive radio resource allocation information from RAN.

NWDAF can use Service Based Interface to receive frequency or frequency band information used by specific UE or specific PDU Session or QoS Flow from RAN or 5G NF. SBI communicates with each other through RESTful API using HTTP protocol.

Examples of frequency and frequency band are as shown in Table 4 below. The center frequency value of frequency used by UE or PDU Session or QoS Flow can be used as is, or a representative value of the corresponding band or index value representing the band can be used.

Table 4 shows examples of frequency according to one embodiment.

TABLE 4

| Band Example | Frequency | Notes |
|---|---|---|
| 900 MHz Band | 890-915 MHz (uplink) | 2G(GSM) |
| | 935-960 MHz (downlink) | |
| 1800 MHZ | 1710-1785 MHz (uplink) | 2G(GSM) |
| Band | 1805-1880 MHz (downlink) | |
| 2100 MHZ | 1920-1980 MHz (uplink) | 3G(UMTS) |
| Band | 2110-2170 MHz (downlink) | |
| 850 MHz Band | 824-849 MHz (uplink) | 3G(UMTS) |
| | 869-894 MHz (downlink) | |
| 1900 MHZ | 1850-1910 MHz (uplink) | 3G(UMTS) |
| Band | 1930-1990 MHz (downlink) | |
| 700 MHz Band | 703-748 MHz (uplink) | 4G(LTE) |
| | 758-803 MHz (downlink) | |
| 800 MHz Band | 797-811 MHz (uplink) | 4G(LTE) |
| | 817-829 MHz (downlink) | |
| 1800 MHZ | 1710-1785 MHz (uplink) | 4G(LTE) |
| Band | 1805-1880 MHz (downlink) | |
| 2600 MHz | 2500-2570 MHz (uplink) | 4G(LTE) |
| Band | 2620-2690 MHz (downlink) | |
| 3.5 GHz Band | 3300-3600 MHz (uplink and/or downlink) | 5G Sub-6G |
| 24 GHz Band | 24.25-27.5 GHZ | 5G mmWave |
| 28 GHz Band | 27.5-28.35 GHZ | 5G mmWave |
| 39 GHz Band | 37-40 GHZ | 5G mmWave |

### [RAT Type]

NWDAF can collect RAT type information used by specific UE or specific PDU Session. For this purpose, NWDAF collects RAT type information used by specific UE or specific PDU Session from AMF or SMF, and can use this in combination with performance measurements and information related to performance measurements collected from AMF, SMF, UPF, or OAM for analysis. By combining performance measurements and information related to performance measurements of specific UE or specific PDU Session or QoS Flow or application collected from AMF, SMF, UPF, or OAM with RAT type information of the corresponding UE, PDU Session, or QoS Flow, performance when using specific frequency at specific location can be inferred and predicted. In addition, performance can be inferred and predicted by further considering one or more of the parameters described above such as QFI, QoS parameters, QoS profile, Traffic Descriptor of application, S-NSSAI, DNN, DNAI, and location.

NWDAF can request RAT type using Namf_EventExposure Subscribe service to AMF and Nsmf_EventExposure Subscribe service to SMF. This corresponds to step 202 in FIG. 2.

Nsmf_EventExposure Subscribe service allows NWDAF to request subscription to SMF including one or more of UE identifier (SUPI), PDU Session ID (PDUSeId), correlation identifier for event (notifId), notification URI for event (notifUri), and event to subscribe (eventSubs). At this time, as shown in Table 5, by including RAT TY CH in eventSubs, subscription can be requested to receive reports whenever RAT type changes. eventSubs may include other events together in addition to RAT TY CH.

SMF can continuously inform NWDAF about RAT information for UE with the corresponding SUPI or PDU Session with PDUSeId using Nsmf_EventExposure Notify service as a response to the corresponding subscription.

Table 5 shows parameters of Nsmf_EventExposure Subscribe and Nsmf_EventExposure Notify services according to one embodiment.

TABLE 5

| Nsmf_EventExposure_Subscription | |
|---|---|
| | NsmfEventExposure |

| supi | |
|---|---|
| pduSeId | |
| notifId | |
| notifUri | |
| eventSubs: | RAT_TY_CH |

| Nsmf_EventExposure_Notify | |
|---|---|
| | NsmfEventExposureNotification |

notifId
eventNotifs

| | |
|---|---|
| event: | RAT_TY_CH |

Namf_EventExposure Subscribe service allows NWDAF to request subscription to AMF including one or more of event list to subscribe (eventList), notification URI for event (eventNotifyUri), correlation identifier for event (notifyCorrelationId), identifier of NF requesting subscription (nfId), UE identifier (SUPI), and UE group identifier (groupId). At this time, as shown in Table 6, eventList may further include “RAT_TYPE_REPORT”. Here, “RAT_TYPE_REPORT” is an example of an identifier requesting reports on RAT type or changes in RAT type.

AMF can continuously inform NWDAF about RAT information for UE with the corresponding SUPI or RAT information for UEs in the corresponding group using Namf_EventExposure Notify service as a response to the corresponding subscription.

Table 6 shows parameters of Namf_EventExposure Subscribe and Namf_EventExposure Notify services according to one embodiment.

TABLE 6

| Namf_EventExposure_Subscription | |
|---|---|
| | AmfEventSubscription |

| | |
|---|---|
| eventList : | ″RAT_TYPE_REPORT″ |

eventNotifyUri
notifyCorrelationId
nfId
supi
groupId

| Namf_EventExposure_Notify | |
|---|---|
| | AmfEventNotification |

notifyCorrelationId
reportList

type
state
timeStamp
ratTypeList

As an example of RAT type usage, it may be any one of the examples in Table 7 below. RAT type may be included in ratTypeList.

Table 7 shows examples of RATtype according to one embodiment.

TABLE 7

| RAT Type | Description |
|---|---|
| “NR” | New Radio |
| “EUTRA” | (WB) Evolved Universal Terrestrial Radio Access |
| “WLAN” | Untrusted Wireless LAN (IEEE 802.11) access |
| “VIRTUAL” | Virtual (see NOTE 1) |
| “NBIOT” | NB IoT |
| “WIRELINE” | Wireline access |
| “WIRELINE_CABLE” | Wireline Cable access |
| “WIRELINE_BBF” | Wireline BBF access |
| “LTE-M” | LTE-M (see NOTE 2) |
| “NR_U” | New Radio in unlicensed bands |
| “EUTRA_U” | (WB) Evolved Universal Terrestrial Radio Access in |
| | unlicensed bands |
| “TRUSTED_N3GA” | Trusted Non-3GPP access |
| “TRUSTED_WLAN” | Trusted Wireless LAN (IEEE 802.11) access |
| “UTRA” | UMTS Terrestrial Radio Access |
| “GERA” | GSM EDGE Radio Access Network |
| “NR_LEO” | NR (LEO) satellite access type |
| “NR_MEO” | NR (MEO) satellite access type |
| “NR_GEO” | NR (GEO) satellite access type |
| “NR_OTHER_SAT” | NR (OTHERSAT) satellite access type |
| “NR_REDCAP” | NR RedCap access type (see NOTE 3) |
| “WB_E_UTRAN_LEO” | WB-E-UTRAN (LEO) satellite access type |
| “WB_E_UTRAN_MEO” | WB-E-UTRAN (MEO) satellite access type |
| “WB_E_UTRAN_GEO” | WB-E-UTRAN (GEO) satellite access type |
| “WB_E_UTRAN_OTHERSAT” | WB-E-UTRAN (OTHERSAT) satellite access type |
| “NB_IOT_LEO” | NB-IoT (LEO) satellite access type |
| “NB_IOT MEO” | NB-IoT (MEO) satellite access type |
| “NB_IOT_GEO” | NB-IoT (GEO) satellite access type |
| “NB_IOT_OTHERSAT” | NB-IoT (OTHERSAT) satellite access type |
| “LTE_M_LEO” | LTE-M (LEO) satellite access type |
| “LTE_M_MEO” | LTE-M (MEO) satellite access type |
| “LTE_M_GEO” | LTE-M (GEO) satellite access type |
| “LTE_M_OTHERSAT” | LTE-M (OTHERSAT) satellite access type |

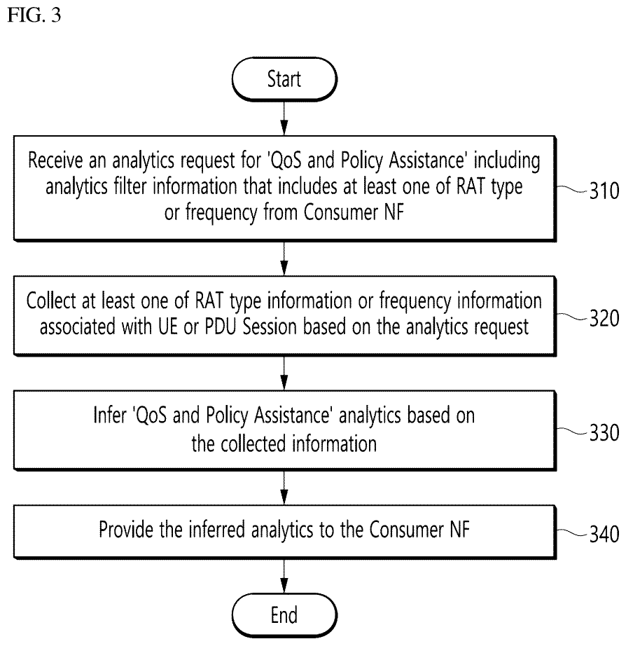

FIG. 3 illustrates an overall flow of an information acquisition method for QoS analysis by NWDAF according to an embodiment of the present disclosure.

Referring to FIG. 3, a method for NWDAF to acquire information for Qos analysis includes the following steps.

In step 310, NWDAF receives an analytics request for ‘QoS and Policy Assistance’ including analytics filter information that includes at least one of RAT type or frequency from Consumer NF. Consumer NF may be PCF, and the analytics request in may be received the form of either Nnwdaf_AnalyticsSubscription Subscribe or Nnwdaf_AnalyticsInfo Request. The analytics request may include one or more of Analytics ID, Target of Analytics Reporting, Qos parameter set(s), Application ID or SDF template(s), and Analytics Filter Information. Analytics Filter Information may include one or more of DNN, Area of Interest, S-NSSAI and NSI ID, RAT Type, and Frequency.

In step 320, NWDAF collects at least one of RAT type information or frequency information associated with UE or PDU Session or Qos Flow based on the analytics request. Information collection can be performed in various ways. NWDAF can collect RAT type information from at least one of AMF or SMF. Reception of RAT type information from SMF can be performed as a response to subscription request for events related to RAT type change (RAT TY CH). Reception of RAT type information from AMF can be performed as a response to subscription request including ‘RAT_TYPE_REPORT’ event. NWDAF can collect frequency information from at least one of RAN, 5G NF, or OAM. NWDAF can directly collect frequency information from RAN, or 5G NF can collect frequency information from RAN and NWDAF can re-collect the corresponding frequency information from 5G NF, or OAM can collect frequency information from RAN NWDAF and can re-collect the corresponding frequency information from OAM.

In step 330, NWDAF infers ‘QoS and Policy Assistance’ analytics based on the collected information. The step of NWDAF inferring analysis may include combining collected frequency information with performance measurements and information related to performance measurements collected from AMF, SMF, UPF, or OAM. Also, it may include combining collected RAT type information with performance measurements and information related to performance measurements collected from AMF, SMF, UPF, or OAM. In the inference process, NWDAF may additionally consider one or more parameters among QFI, Qos parameters, Qos profile, Traffic Descriptor of application, S-NSSAI, DNN, DNAI, and location information. Frequency information may include at least one of a number representing individual frequency or a value representing frequency band.

In step 340, NWDAF provides the inferred analytics to Consumer NE. NWDAF provides analysis results using corresponding messages according to the request of Nnwdaf_AnalyticsSubscription Subscribe or Nnwdaf_AnalyticsInfo Request received in step 310. NWDAF can provide analysis results as Request-Response services or Subscribe-Notify services. NWDAF can provide expected QoS when using specific QoS parameters for specific UEs or groups of UEs to Consumer NF.

In one embodiment, any one of steps 320 and 330 may be performed before step 310. That is, NWDAF can process Consumer NE requests while pre-collecting information and preparing analysis.

In one embodiment, to manage and optimize QoS in 5G networks, NWDAF monitors and analyzes network performance to support PCF in effectively applying and adjusting QoS policies.

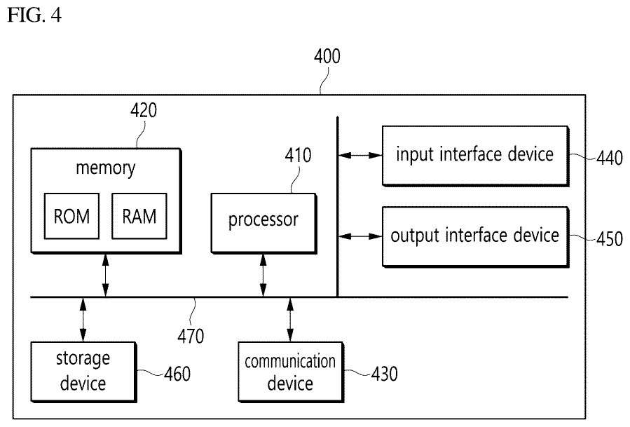

FIG. 4 shows a configuration of a network function apparatus in a wireless communication system according to an embodiment of the present disclosure. Referring to FIG. 4, network function apparatus 400 may include at least one processor 410, memory 420, and communication device 430 connected to the network to perform communication. Communication device 430 may be referred to as a transceiver. Additionally, network function apparatus 400 may further include input interface device 440, output interface device 450, storage device 460, and the like. Each component included in network function apparatus 400 is connected by bus 470 and can communicate with each other.

However, each component included in network function apparatus 400 may be connected through individual interfaces or individual buses centered on processor 410, rather than common bus 470. For example, processor 410 may be connected to at least one of memory 420, communication device 430, input interface device 440, output interface device 450, and storage device 460 through dedicated interfaces.

Processor 410 can execute program instructions stored in at least one of memory 420 and storage device 460. Processor 410 may mean a central processing unit, graphics processing unit, or dedicated processor on which methods according to embodiments of the present disclosure are performed. Each of memory 420 and storage device 460 may be configured with at least one of volatile storage media and non-volatile storage media. For example, memory 420 may be configured with at least one of read-only memory and random access memory.

Network function apparatus 400 can perform various network functions such as NWDAF, AMF, SMF, UPF, PCF, and RAN. When network function apparatus 400 operates as NWDAF, processor 410 may be configured to: receive, from Consumer NF, an analytics request for ‘QoS and Policy Assistance’ including analytics filter information that includes at least one of RAT type or frequency; collect, based on the analytics request, at least one of RAT type information or frequency information associated with UE or PDU Session or QoS Flow; infer ‘QoS and Policy Assistance’ analytics based the collected information; and provide the inferred analytics to Consumer NF.

When network function apparatus 400 operates as AMF or SMF, processor 410 may be configured to receive RAT type information requests from NWDAF and provide RAT type information to NWDAF through EventExposure service.

When network function apparatus 400 operates as RAN, processor 410 may be configured to provide frequency information or RAT type information for UE or PDU Session to NWDAF or other network functions.

Methods according to embodiments described in the claims or specification of the present disclosure may be implemented in hardware, software, or a combination of hardware and software.

When implemented in software, a computer-readable storage medium storing one or more programs (software modules) may be provided. One or more programs stored in the computer-readable storage medium are configured for execution by one or more processors within an electronic device. One or more programs include instructions that cause the electronic device to execute methods according to embodiments described in the claims or specification of the present disclosure.

Such programs (software modules, software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage devices, or magnetic cassette. Alternatively, it may be stored in memory configured with some or all combinations thereof. Also, each configuration memory may be included in plurality.

Additionally, programs may be stored in attachable storage devices that can be accessed through communication networks such as Internet, Intranet, local area network (LAN), wide area network (WAN), or storage area network (SAN), or combinations thereof. Such storage devices can connect to devices performing embodiments of the present disclosure through external ports. Also, separate storage devices on communication networks may connect to devices performing embodiments of the present disclosure.

In the specific embodiments of the present disclosure described above, components included in the disclosure are expressed in singular or plural forms according to presented specific embodiments. However, singular or plural expressions are selected appropriately for situations presented for convenience of description, and the present disclosure is not limited to singular or plural components. Components expressed in plural may be configured in singular, and components expressed in singular may be configured in plural.

While specific embodiments have been described in the detailed description of the present disclosure, various modifications are possible within the scope of the present disclosure. Therefore, the scope of the present disclosure should not be limited to the described embodiments but should be determined by the scope of the claims described below as well as equivalents to the scope of the claims.

Methods according to embodiments described in the claims or specification of the present disclosure may be implemented in the form of hardware, software, or a combination of hardware and software.

When implemented in software, a computer-readable storage medium storing one or more programs (software modules) may be provided. One or more programs stored in the computer-readable storage medium are configured for execution by one or more processors within an electronic device. One or more programs include instructions that cause the electronic device to execute methods according to embodiments described in the claims or specification of the present disclosure.

Such programs (software modules, software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage devices, magnetic cassettes. Alternatively, they may be stored in memory composed of some or all combinations thereof. Additionally, each constituent memory may be included in multiple numbers.

Additionally, programs may be stored in attachable storage devices that can be accessed through communication networks such as the Internet, Intranet, local area network (LAN), wide area network (WAN), or storage area network (SAN), or combinations thereof. Such storage devices may connect to devices performing embodiments of the present disclosure through external ports. Additionally, separate storage devices on communication networks may connect to devices performing embodiments of the present disclosure.

In the specific embodiments of the present disclosure described above, components included in the disclosure have been expressed in singular or plural forms according to presented specific embodiments. However, singular or plural expressions are appropriately selected for situations presented for convenience of explanation, and the present disclosure is not limited to singular or plural components. Components expressed in plural may be configured in singular, or components expressed in singular may be configured in plural.

Meanwhile, while specific embodiments have been described in the detailed description of the present disclosure, various modifications are possible within the scope of the present disclosure. Therefore, the scope of the present disclosure should not be limited to described embodiments but should be determined by the scope of claims described below as well as equivalents thereof.

What is claimed is:

1. A operation method of a Network Data Analytics Function (NWDAF) for acquiring information for Quality of Service (QoS) analysis in a wireless communication system, the method comprising:
receiving, from a Consumer Network Function (NF), an analytics request for ‘QoS and Policy Assistance’ including analytics filter information that includes at least one of Radio Access Technology (RAT) type or frequency; collecting, based on the analytics request, at least one of the RAT type information or the frequency information associated with a User Equipment (UE) or PDU Session or QoS Flow;
inferring the ‘QoS and Policy Assistance’ analytics based on the collected information; and providing the inferred analytics to the Consumer NF.

2. The method of claim 1, wherein collecting the RAT type information comprises receiving the RAT type information from at least one of Access and Mobility Management Function (AMF), Session Management Function (SMF), or Operations, Administration, and Maintenance (OAM).

3. The method of claim 1, wherein collecting the frequency information comprises receiving the frequency information from at least one of Radio Access Network (RAN), 5G Network Function (5G NF), or Operations, Administration, and Maintenance (OAM).

4. The method of claim 2, wherein receiving the RAT type information from the SMF is performed as a response to a subscription request for events related to RAT type change (RAT TY CH).

5. The method of claim 2, wherein receiving the RAT type information from the AMF is performed as a response to a subscription request including a ‘RAT_TYPE_REPORT’ event.

6. The method of claim 1, wherein inferring the analytics comprises combining the collected frequency information with performance measurements and information related to the performance measurements collected from Access and Mobility Management Function (AMF), Session Management Function (SMF), User Plane Function (UPF), or Operations, Administration, and Maintenance (OAM).

7. The method of claim 1, wherein inferring the analytics comprises combining the collected RAT type information with performance measurements and information related to the performance measurements collected from Access and Mobility Management Function (AMF), Session Management Function (SMF), User Plane Function (UPF), or Operations, Administration, and Maintenance (OAM).

8. The method of claim 1, wherein the frequency information includes at least one of a number representing an individual frequency or a value representing a frequency band.

9. An apparatus of a Network Data Analytics Function (NWDAF) for acquiring information for Quality of Service (QoS) analysis in a wireless communication system, the apparatus comprising: a transceiver; and a controller operatively connected to the transceiver, wherein the controller is configured to:
receive, from a Consumer Network Function (NF), an analytics request for ‘QoS and Policy Assistance’ including analytics filter information that includes at least one of Radio Access Technology (RAT) type or frequency;
collect, based on the analytics request, at least one of or the frequency information the RAT type information associated with a User Equipment (UE) or PDU Session or QoS Flow;
infer the ‘QoS and Policy Assistance’ analytics based on the collected information; and provide the inferred analytics to the Consumer NF.

10. The apparatus of claim 9, wherein collecting the RAT type information comprises receiving the RAT type information from at least one of Access and Mobility Management Function (AMF), Session Management Function (SMF), or Operations, Administration, and Maintenance (OAM).

11. The apparatus of claim 9, wherein collecting the frequency information comprises receiving the frequency information from at least one of Radio Access Network (RAN), 5G Network Function (5G NF), or Operations, Administration, and Maintenance (OAM).

12. The apparatus of claim 10, wherein receiving the RAT type information from the SMF is performed as a response to a subscription request for events related to RAT type change (RAT TY CH).

13. The apparatus of claim 10, wherein receiving the RAT type information from the AMF is performed as a response to a subscription request including a ‘RAT_TYPE_REPORT’ event.

14. The apparatus of claim 9, wherein the controller is configured to, for inferring the analytics, combine the collected frequency information with performance measurements and information related to the performance measurements collected from Access and Mobility Management Function (AMF), Session Management Function (SMF), User Plane Function (UPF), or Operations, Administration, and Maintenance (OAM).

15. The apparatus of claim 9, wherein the controller is configured to, for inferring the analytics, combine the collected RAT type information with performance measurements and information related to the performance measurements collected from Access and Mobility Management Function (AMF), Session Management Function (SMF), User Plane Function (UPF), or Operations, Administration, and Maintenance (OAM).

16. The apparatus of claim 9, wherein the frequency information includes at least one of a number representing an individual frequency or a value representing a frequency band.
